(19) United States
(12) Patent Application Publication
(10) Pub. No.: US 2008/0049270 A1
(43) Pub. Date: Feb. 28, 2008

(54) IMAGE READING DEVICE AND MULTIFUNCTION APPARATUS

(75) Inventor: Satoshi OGUCHI, Matsumoto-shi (JP)

Correspondence Address: WORKMAN NYDEGGER, 60 EAST SOUTH TEMPLE, 1000 EAGLE GATE TOWER, SALT LAKE CITY, UT, 84111, US

(73) Assignee: SEIKO EPSON CORPORATION, Tokyo (JP)

(21) Appl. No.: 11/840,838

(22) Filed: Aug. 17, 2007

(30) Foreign Application Priority Data
Aug. 17, 2006 (JP) 2006-222298

(51) Int. Cl. H04N 1/04

(52) U.S. Cl. 358/474

(57) ABSTRACT

In a scanner device including a reflective light source disposed at the same side as a side at which an image pickup element is disposed with respect to a document table glass and a transmissive light source disposed at a side opposite the image pickup element with the document table glass arranged therebetween, an image pickup element moving mechanism moves the image pickup element in a sub-scanning direction. A light source moving mechanism moves the transmissive light source in the sub-scanning direction. A film holder is movable to a set position on the document table glass and to a different position from the set position and positions a transparent document when being positioned in the set position. A coupling mechanism couples the image pickup element moving mechanism and the light source moving mechanism together such that both the moving mechanisms are capable of working together via a gear when the film holder is positioned in the set position.

### BACKGROUND OF THE INVENTION

The present invention relates to an image reading device and a multifunction apparatus.

Conventionally, an image reading device is known that includes a reflective reading mechanism emitting light from a reflective light source disposed at the same side as a side at which an image pickup element is disposed with respect to a document table for holding a document and reading light reflected from the document and, in addition, a transmissive reading mechanism emitting light from a transmissive light source for transmission disposed opposite the image pickup device with the document table arranged therebetween and reading light having passed through the document. One such example of the image reading device is an image device that reads an image of a document while moving a light source and an image pickup element concurrently in a scanning direction (see, for example, Patent Document 1 below).
Patent Document 1: JP-A-10-051596

However, a technique described in the Patent Document 1 requires an image reading device to have two driving sources when moving an image pickup element and a transmissive light source arranged so as to face each other with a document table arranged therebetween using driving forces from respective driving sources to read a transparent document. As a result, there is a problem in which the image reading device has a large size and the power consumption of the image reading device is increased.

One approach to addressing this is to allow an image pickup element and a transmissive light source to work together using a single driving source by coupling moving mechanisms for moving the image pickup element and the transmissive light source together. In this case, however, the transmissive light source, which is not used when a reflective document is read, is always moved by working with movement of the image pickup element. As a result, there is a problem in which an unnecessary heavy load is imposed on the driving source and an unnecessary large amount of power is consumed.

One of measures for solving the problem is to cause a user to perform switching between on and off of settings of working together depending on the type of a document to be read. However, there is a problem in which such a switching operation is troublesome to the user and a malfunction may be caused by mishandling by the user.

### SUMMARY OF THE INVENTION

An image reading device according to the invention, an image reading device includes a first light source disposed at the same side as a side at which an image pickup element is disposed with respect to a document table and a second light source disposed at a side opposite the image pickup element with the document table arranged therebetween. The image reading device includes an image pickup element moving mechanism that moves the image pickup element in a sub-scanning direction, a light source moving mechanism that moves the second light source in the sub-scanning direction, a positioning member that is movable to a set position on the document table and to a different position from the set position and that shows a set position for a transparent document when being positioned in the set position, and a coupling mechanism that couples the image pickup element moving mechanism and the light source moving mechanism together such that both the moving mechanisms are capable of working together when the positioning member is positioned in the set position.

According to the invention, the light source moving mechanism and the image pickup element moving mechanism can be moved using the driving force of the same driving source. Thus, the size and weight of the image reading device can be reduced, compared with when the light source moving mechanism and the image pickup element moving mechanism have respective driving sources. Additionally, the positioning member disposed in the set position enables the coupling mechanism to transmit the driving force to the light source moving mechanism without the need for a special operation of a user to transmit the driving force to the light source moving mechanism. Accordingly, the image reading device can be miniaturized without sacrificing user convenience.

The coupling mechanism in the image reading device according to the invention includes a rotary member that is disposed on the positioning member and that is movable with respect to the positioning member. The coupling mechanism couples the image pickup element moving mechanism and the light source moving mechanism together such that both the moving mechanisms are capable of working together via the rotary member when the positioning member is positioned in the set position.

According to the invention, when the positioning member is positioned in the set position, the light source moving mechanism and the image pickup element moving mechanism can be coupled via the rotary member such that both the moving mechanisms can work together, and the light source moving mechanism and the image pickup element moving mechanism can be moved using the driving force of the same driving source. Accordingly, the size and weight of the image reading device can be reduced, compared with when the light source moving mechanism and the image pickup element moving mechanism have respective driving sources, while at the same time the power consumption of the driving source can be minimized without sacrificing user convenience.

The coupling mechanism in the image reading device according to the invention includes a magnetic body and couples the image pickup element moving mechanism and the light source moving mechanism together such that both the moving mechanisms are capable of working together by using the magnetic force of the magnetic body.

According to the invention, the light source moving mechanism and the image pickup element moving mechanism can be coupled using the magnetic force of the magnetic member such that both the moving mechanisms can work together. This enables the light source moving mechanism and the image pickup element moving mechanism to be moved using the driving force of the same driving source. Accordingly, the size and weight of the image reading device can be reduced, compared with when the light source moving mechanism and the image pickup element moving mechanism have respective driving sources, while at the same time the power consumption of the driving source can be minimized without sacrificing user convenience.

The coupling mechanism in the image reading device according to the invention includes coupling members that are attracted by the magnetic force of the magnetic body. The coupling members couple the image pickup element moving mechanism and the light source moving mechanism together such that both the moving mechanisms are capable of working together by causing flat surfaces orthogonal to a direction in which the coupling members face each other to come into contact with each other.

According to the invention, the light source moving mechanism and the image pickup element moving mechanism can be coupled using the magnetic force of the magnetic member such that both the moving mechanisms can work together, and the coupling portions of the coupling mechanism can have the torque limiting function. This enables the light source moving mechanism and the image pickup element moving mechanism to be moved using the driving force of the same driving source. Accordingly, the size and weight of the image reading device can be reduced, compared with when the light source moving mechanism and the image pickup element moving mechanism have respective driving sources, while at the same time the power consumption of the driving source can be minimized without sacrificing user convenience. In addition, durability of the image reading device can be increased.

The rotary member in the image reading device according to the invention positions the positioning member to the set position when being positioned in a position for coupling the image pickup element moving mechanism and the light source moving mechanism together.

According to the invention, by positioning the rotary member in the position at which the coupling mechanism can be coupled, the positioning member can also be positioned in the set position. This eliminates the need for a particular structure for positioning the positioning member. Accordingly, the image reading device can be miniaturized, while at the same time the power consumption of the driving source can be minimized without sacrificing user convenience.

The image reading device according to the invention further includes a cover member that is shaped so as to block outside light from being incident on the image pickup element through the document table and that is capable of being in contact with and separated from the document table. The second light source is disposed on the cover member.

According to the invention, because the second light source is disposed on the cover member, the second light source can be arranged in an appropriate position by an operation of covering the document table with the cover member alone. In addition, the image reading device can be miniaturized, while at the same time the power consumption of the driving source can be minimized without sacrificing user convenience.

The second light source in the image reading device according to the invention includes a light-emitting diode (LED).

According to the invention, the light source can light up more quickly, compared with when a fluorescent lamp is used. Accordingly, reading a document can start quickly, the image reading device can be miniaturized, and the power consumption of the driving source can be minimized without sacrificing user convenience.

A multifunction apparatus according to the invention includes the image reading device described above and an image forming device that forms, on a recording medium, an image corresponding to intensity of light incident on the image pickup element included in the image reading device.

According to the invention, the image reading mechanism in the multifunction apparatus can be miniaturized, while at the same time the power consumption of the driving source can be minimized without sacrificing user convenience.

### BRIEF DESCRIPTION OF THE DRAWINGS

FIG. 1 is a perspective view that illustrates an outer appearance of a scanner device according to a first embodiment.

FIG. 2 is a front view of the scanner device according to the first embodiment cut in a vertical direction.

FIG. 3 is a partial cutaway perspective view of the scanner device.

FIG. 4 is an exploded perspective view of a transmissive light source.

FIG. 5 is a (first) cut front view that illustrates an enlarged part of the scanner device.

FIG. 6 is a (second) cut front view that illustrates the enlarged part of the scanner device.

FIG. 7 is a perspective view that illustrates an outer appearance of the scanner device when a film holder is detached.

FIG. 8 is a perspective view that illustrates an outer appearance of the scanner device when the film holder is placed.

FIG. 9 is a partial cutaway perspective view of the scanner device according to a second embodiment.

FIG. 10 is a (first) cut front view that illustrates an enlarged part of the scanner device.

FIG. 11 is a (second) cut front view that illustrates the enlarged part of the scanner device.

FIG. 12 is a perspective view of a multifunction apparatus according to a third embodiment.

### DETAILED DESCRIPTION OF THE EMBODIMENTS

### First Embodiment

An image reading device according to a first preferred embodiment of the invention is described below with reference to the accompanying drawings. The first embodiment indicates an application example to a scanner device that actualizes the image reading device according to the invention.

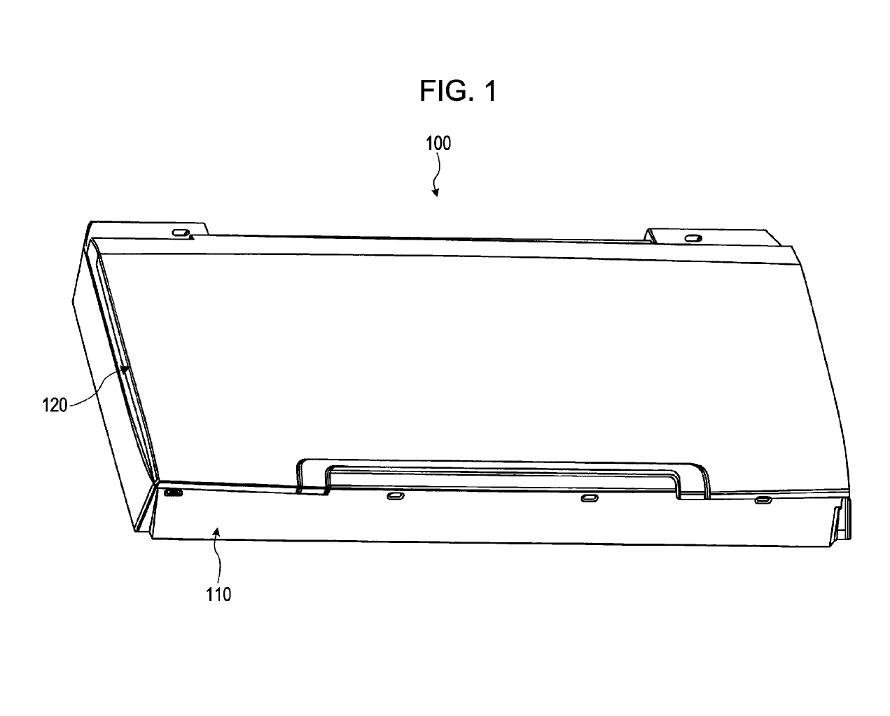

FIG. 1 is a perspective view that illustrates an outer appearance of the scanner device according to the first embodiment. First, the outer appearance of a scanner device 100 will described. As illustrated in FIG. 1, the scanner device 100 includes a main body unit 110 and a light source unit 120 for a transparent document (hereinafter referred to as a “TPU unit”) serving as a cover member.

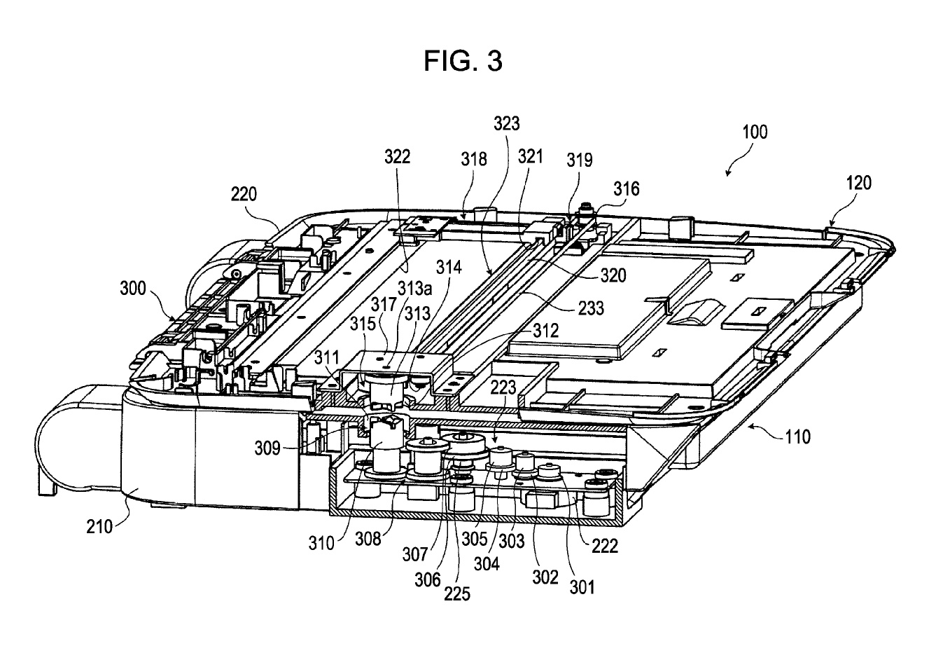

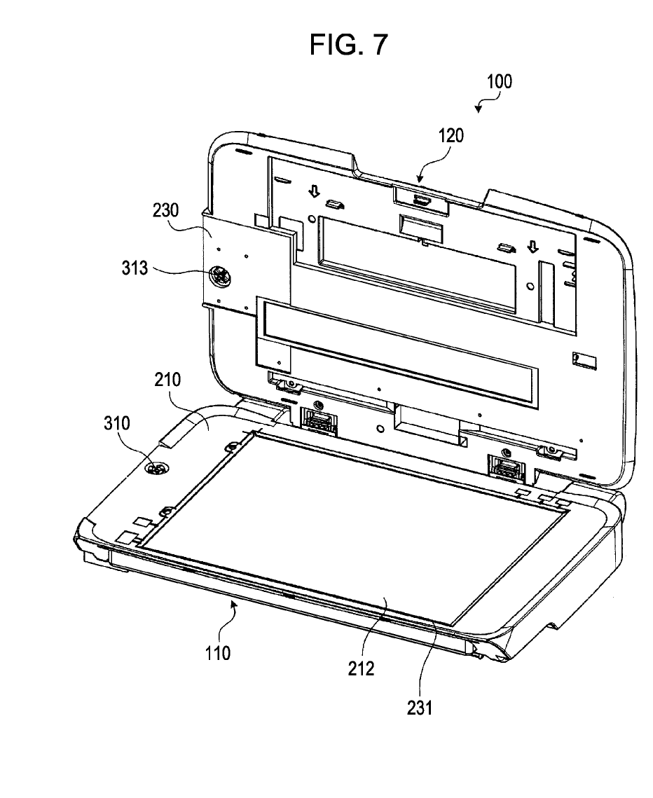

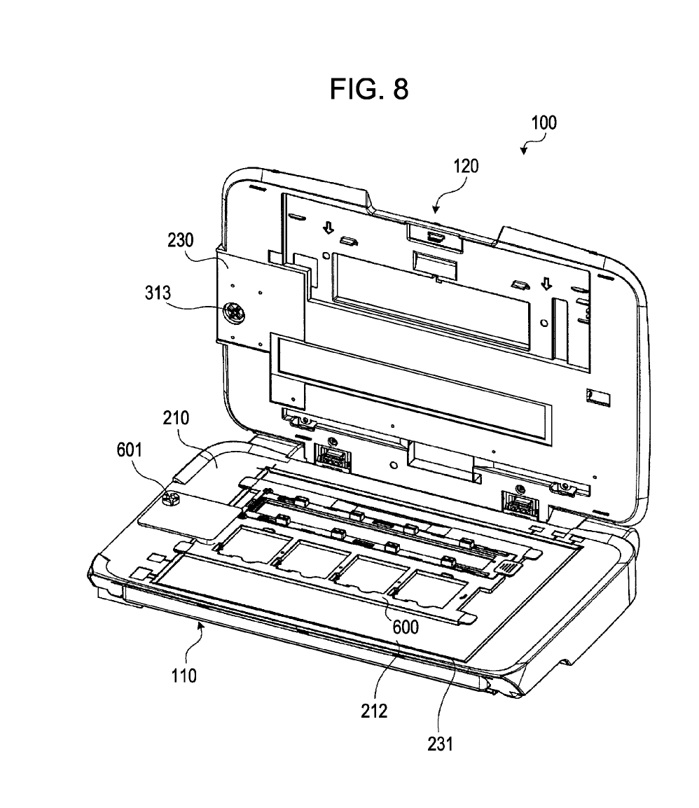

The TPU unit 120 is arranged so as to face the main body unit 110 and is coupled to the main body unit 110 via a hinge (see reference numeral 300 in FIG. 3). The TPU unit 120 is coupled thereto so as to be able to pivot about the hinge in a direction that is separated from the main body unit 110 being in a state illustrated in FIG. 1 (see FIGS. 7 and 8).

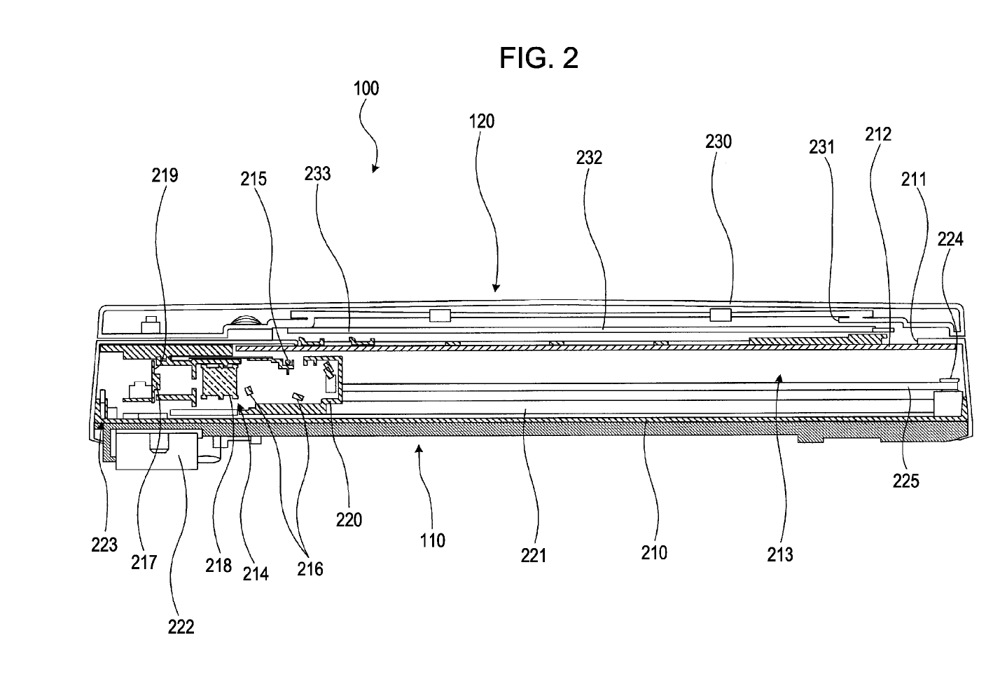

FIG. 2 is a front view of the scanner device according to the first embodiment cut in a vertical direction. A general structure of the scanner device 100 according to the first embodiment will be described next. As illustrated in FIG. 2, the scanner device 100 includes a main body housing 210 constituting the outer frame of the main body unit 110 and a TPU housing 230 constituting the outer frame of the TPU unit 120.

First, a general structure of the main body unit 110 will be described. The main body housing 210 of the main body unit 110 has an opening 211 open to the TPU housing 230. The opening 211 is provided with a document table glass 212 covering the opening 211. A predetermined position on the document table glass 212 (see FIG. 8) is a set position at which a film holder (described later) is set.

An optical member 214 for optically reading a document placed on the document table glass 212 is disposed in a space 213 formed between the main body housing 210 and the document table glass 212. The optical member 214 includes a reflective light source 215 serving as a first light source and emitting light toward the document table glass 212, a plurality of mirrors 216 for guiding light reflected from the document after having been emitted from the reflective light source 215 to a predetermined path, an image pickup element 217 for receiving light guided by the mirrors 216, and a lens 218 for forming an image on the image pickup element 217 from the light guided by the mirrors 216.

The image pickup element 217 can be, for example, a photodiode that photoelectrically converts an image formed on a light-receiving surface and then outputs an electric signal corresponding to the amount of light received for each element. In the scanner device 100, a linear image sensor including the photodiodes linearly aligned along in a main-scanning direction on a scanning circuit substrate 219 is used as the image pickup element 217.

A scanner carriage 220 is disposed in the space 213. The scanner carriage 220 is slidable along a carriage guide 221 being parallel with the document table glass 212 and extending in a sub-scanning direction.

The scanner carriage 220 receives a driving force generated by a motor 222 serving as a driving source via an image pickup element moving mechanism 223 coupled to the motor 222. The image pickup element moving mechanism 223 is coupled thereto via a gear train coupled to a driving shaft of the motor 222 and a driving belt 225 wound between a gear of the gear train and a driven gear 224. The details will be described later (see FIG. 3). The scanner carriage 220 is coupled to the driving belt 225.

The driving force generated by the motor 222 is transmitted to the scanner carriage 220 via the image pickup element moving mechanism 223, thereby moving the scanner carriage 220 in the sub-scanning direction along the document table glass 212. The optical member 214 is mounted on the scanner carriage 220. With movement of the scanner carriage 220, the optical member 214 moves in the sub-scanning direction along the document table glass 212.

The TPU unit 120 will be described next. The TPU unit 120 is provided with a transmissive light source serving as a second light source at a position at which the transmissive light source illuminates a document (see FIG. 3). The TPU unit 120 acts as a light shielding member that blocks outside light from being incident on the document table glass 212 during reading of a transparent document (described later). The TPU housing 230 of the TPU unit 120 has an opening 231 open to the main body housing 210 at a side that faces the main body housing 210.

The TPU housing 230 is provided with the transmissive light source (see reference numeral 318 in FIG. 3). The transmissive light source is used during an operation of reading a document that allows light to pass therethrough, such as a photographic film, (hereinafter referred to as a “transparent document”) and emits light toward the document table glass 212. The transmissive light source is movable in the sub-scanning direction along the document table glass 212. Although the detailed illustration and description are omitted, a power transmission mechanism disposed on the TPU unit 120 includes, for example, a group of pulleys coupled to the image pickup element moving mechanism 223, a driving belt 233, and a pair of gears around which the driving belt 233 is wound (see FIG. 3 in part).

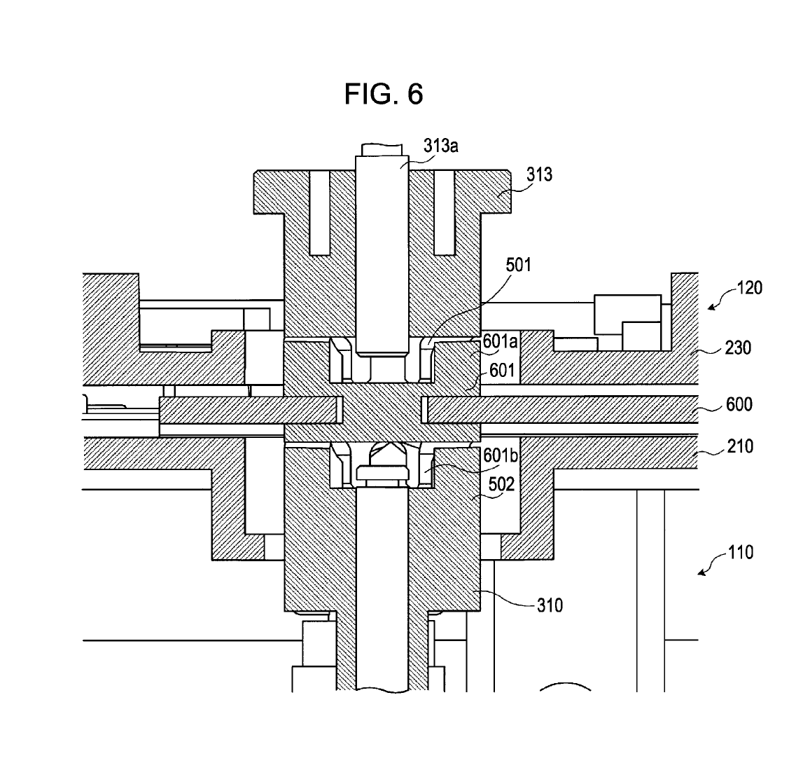

In the case of an operation of reading a transparent document, the film holder serving as a positioning member (see reference numeral 600 in FIGS. 6 and 8) is positioned at a set position on the document table glass 212 between the main body unit 110 and the TPU unit 120. The film holder shows a set position for a film to set the film at a film reading position on the document table glass 212, and fixes the set film at the film reading position.

In the case of an operation of reading a document that reflects light, such as paper, (hereinafter referred to as a “reflective document”), a protective mat 232 having a shape that covers the whole of the opening 231 of the TPU housing 230 is removably disposed.

The protective mat 232 is made of an opaque material. The protective mat 232 presses a reflective document against the document table glass 212 and blocks light emitted from light sources other than the reflective light source 215 (e.g., the transmissive light source and the exterior of the device) toward the document. This enables light emitted from the reflective light source 215 to the document to be efficiently reflected to the mirrors 216.

The protective mat 232 is disposed between the TPU unit 120 and the document table glass 212 and may be, for example, removable from a side of the TPU housing 230 adjacent to the main body housing 210. In the case in which the scanner device 100 reads a transparent document, the protective mat 232 is detached. In this case, light emitted from the transmissive light source passes through the transparent document, and forms an image on the light receiving surface of the image pickup element 217.

In the foregoing, the protective mat 232 is detached from the scanner device 100. However, the protective mat 232 may be displaced from between the TPU unit 120 and the document table glass 212 without being detached from the scanner device 100. For example, a coupling portion that continuously couples the protective mat 232 and the scanner device 100 may be provided to an end of the protective mat 232 to allow the protective mat 232 to be displaced from between the TPU unit 120 and the document table glass 212 instead of complete detaching of the protective mat 232 from the scanner device 100.

FIG. 3 is a partial cutaway perspective view of the scanner device and illustrates a state in which a part of the TPU housing 230 and the main body housing 210 is cut to illustrate its section. Reference numeral 300 denotes a hinge that couples the main body unit 110 and the TPU unit 120. Each component to which the driving force of the motor 222 is transmitted will be described below using FIG. 3.

As illustrated in FIG. 3, the image pickup element moving mechanism 223 disposed on the main body housing 210 includes a gear 301 fixed on the driving shaft of the motor 222 and a gear train of gears 302 to 306 coupled to the gear 301. A shaft being the axis of rotation of the gear 306 is provided with the gear on which the driving belt 225 is placed.

The image pickup element moving mechanism 223 rotates the driving belt 225 by transmitting the driving force generated by the motor 222 to the driving belt 225 via the gears 301 to 306. This enables the scanner carriage 220 coupled to the driving belt 225 to be moved in the sub-scanning direction.

A rotating shaft of the gear 306 is provided with a pulley 307 whose axis of rotation is the rotating shaft. The pulley 307 is coupled to a gear 310 included in a coupling mechanism 309 via a group of pulleys 308 rotated with the rotation of the pulley 307. The gear 310 meshes with a gear 313 disposed on the TPU unit 120 via openings 311 and 312 open to the TPU unit 120 at the upper surface of the main body housing 210 and a rotary member (see reference numeral 601 in FIG. 6) disposed on the film holder, which will be described later, thereby forming the coupling mechanism 309.

The TPU housing 230 is provided with a pulley group 315 coupling a first gear 314 of the pair of gears around which the driving belt 233 is wound and the gear 313 together. A second gear 316 of the pair of gears is rotated so as to follow rotation of the driving belt 233. The gears 314 and 316 face each other along the sub-scanning direction. The driving belt 233, the gears 314 and 316 of the pair of gears, and the pulley group 315 constitute a light source moving mechanism 323.

Reference numeral 317 denotes a stay that supports the shafts of the gear 313, the pulleys of the pulley group 315, and the first gear 314. The gear 313 is rotatable about a shaft 313a supported by the stay 317. A gap is present between the gear 313 and the gear 310, so in this state, the gear 313 and the gear 310 do not mesh with each other.

Reference numeral 318 denotes the transmissive light source, which is previously described. The transmissive light source 318 is coupled to the driving belt 233 at a fixing portion 319 provided on the transmissive light source 318. This enables the transmissive light source 318 to be moved along the sub-scanning direction with rotation of the driving belt 233.

The TPU housing 230 is provided with a guide rail 320 extending along the sub-scanning direction at a position that is adjacent to a side portion of the driving belt 233 and that overlaps a moving path of the transmissive light source 318. The guide rail 320 is fit in a groove 321 formed on the transmissive light source 318 at a position facing the guide rail 320. This enables the transmissive light source 318 to be stably moved along the sub-scanning direction.

Light emitted from the transmissive light source 318 is guided toward the document table glass 212 via an opening 322 formed in the TPU housing 230. The opening 322 covers an area for use in reading a film in the transmissive light source 318.

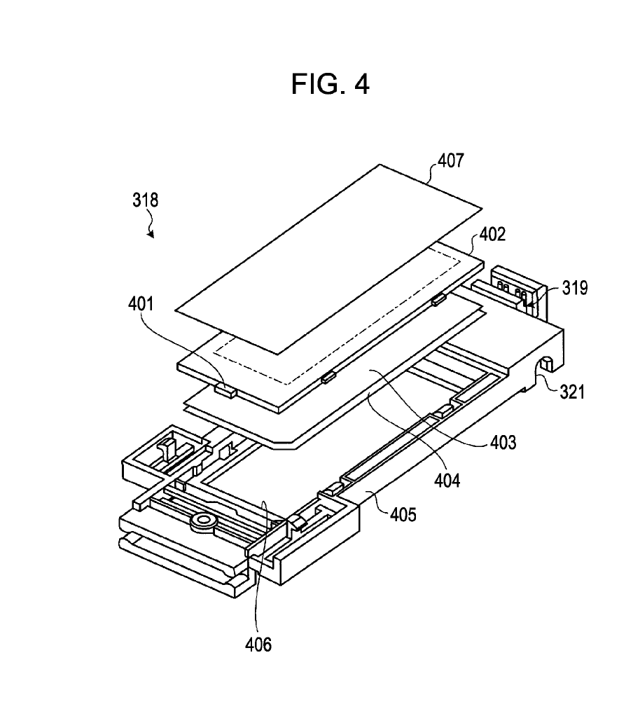

FIG. 4 is an exploded perspective view of the transmissive light source. A structure of the transmissive light source 318 will be described next. As illustrated in FIG. 4, the transmissive light source 318 includes a light-emitting diode (LED) 401 and a light guide plate 402 propagating light emitted by the LED 401. By use of the light guide plate 402, a larger area than an illuminated area by a single LED can be illuminated. In FIG. 4, imaginary lines represent an effective light-emitting area in the light guide plate 402.

Light propagated in the light guide plate 402 is directed toward the document table glass 212 from an opening 406 formed in a support frame 405 through a prism sheet 403 and a diffusion sheet 404. By use of intervention of the prism sheet 403 and the diffusion sheet 404, a larger area can be illuminated with light after being propagated in the light guide plate 402.

A reflector 407 reflecting light having been propagated in the light guide plate 402 toward the opening 406 is disposed in the transmissive light source 318 at a side opposite the opening 406 with the light guide plate 402 arranged therebetween. By use of the reflector 407, the light propagated in the light guide plate 402 can be efficiently directed toward the document table glass 212.

The fixing portion 319 is arranged adjacent to a side portion of the support frame 405 and is open upward so as to hold the driving belt 233 from a side adjacent to the document table glass 212. Although the transmissive light source 318 can include a fluorescent lamp as an alterative to the LED 401, the use of the LED 401 enables more quick lighting, resulting in a quick reading operation of the scanner device 100.

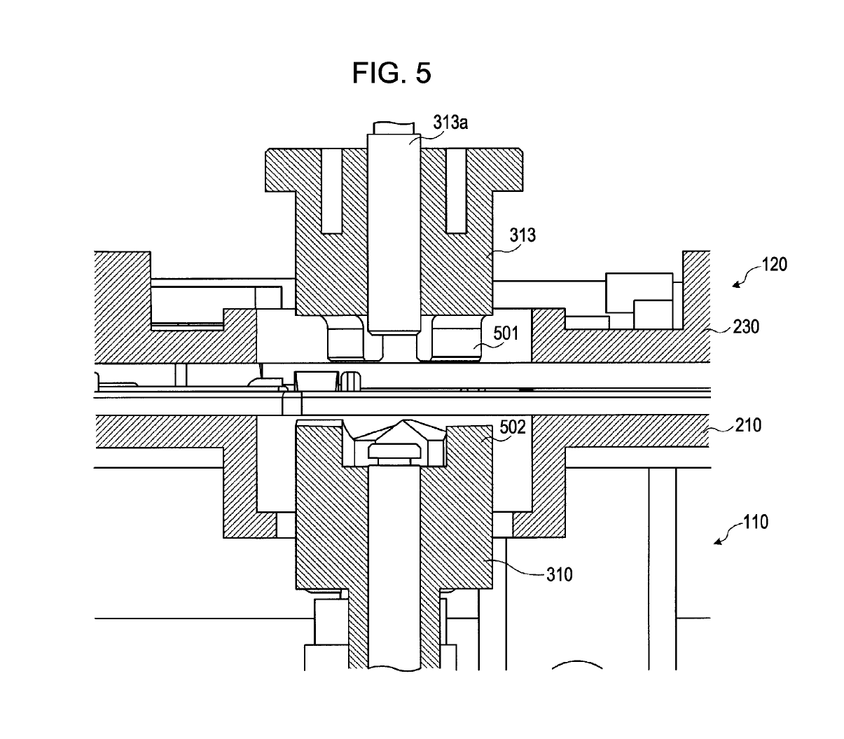

FIG. 5 is a (first) cut front view that illustrates an enlarged part of the scanner device. FIG. 5 illustrates a state in which the film holder is detached from the main body unit 110. As illustrated in FIG. 5, the gear 313 of the coupling mechanism 309 has gear teeth 501 protruding toward the main body unit 110. The gear 310 of the coupling mechanism 309 has gear teeth 502 capable of meshing with the gear teeth 501. As previously described, because a gap is present between the gear 313 and the gear 310, the gear 313 and the gear 310 do not mesh with each other in this state.

FIG. 6 is a (second) cut front view that illustrates the enlarged part of the scanner device. FIG. 6 illustrates a state in which the film holder is positioned in the main body unit 110. As illustrated in FIG. 6, the film holder 600 is provided with the gear 601 rotatable about the axis orthogonal to a surface of the film holder 600. The gear 601 has gear teeth 601a and 601b.

When the film holder 600 lies in a set position, the gear teeth 601a meshes with the gear teeth 501 of the gear 313. When the film holder 600 lies in a set position, the gear teeth 601a meshes with the gear teeth 501 of the gear 313, the gear teeth 601b meshes with the gear teeth 502 of the gear 310. Thus, the gear 310 and the gear 313 are coupled together through the gear 601, and the driving force of the motor 222 is transmitted to the light source moving mechanism 323.

FIG. 7 is a perspective view that illustrates an outer appearance of the scanner device when the film holder is detached. FIG. 8 is a perspective view that illustrates an outer appearance of the scanner device when the film holder is positioned. As illustrated in FIG. 7, the gear 310 does not protrude from the main body housing 210, and the gear 313 also does not protrude from the TPU housing 230. Thus, when the TPU unit 120 is lowered to the main body unit 110 in a state in which the film holder 600 is detached, a gap is present between the gear 310 and the gear 313, so the gear 310 and the gear 313 do not mesh with each other (see FIG. 5).

In contrast, as illustrated in FIG. 8, when the film holder 600 is positioned in the set position in the main body unit 110, the gear 310 and the gear 601 of the film holder 600 mesh with each other, and the gear 601 protrudes from the main body unit 110. When the TPU unit 120 is lowered to the main body unit 110 in this state, the gear 601 meshes with the gear 313 (see FIG. 6), and the driving force of the motor 222 is transmitted to the light source moving mechanism 323.

In the foregoing, the film holder 600 is detached from the scanner device 100. However, the film holder 600 may be moved from the set position to a different position from the set position without being detached from the scanner device 100. For example, a coupling portion that continuously couples the film holder 600 and the scanner device 100 may be provided to an end of the film holder 600 to allow the film holder 600 to be displaced from between the TPU unit 120 and the document table glass 212 instead of complete detaching of the film holder 600 from the scanner device 100.

Although not illustrated, the scanner device 100 includes, in addition to the components described above, an operating panel that accepts various instruction operations from a user, various control circuits that control driving of components in the scanner device 100, and a control system that controls the various control circuits in response to the various instruction operations. The operating panel accepts an operation of an instruction to read a transmissive document, an operation of an instruction to read a transparent document, and other operations.

Additionally, although not illustrated, the scanner device 100 may include a communication interface (I/F) that enables communication with an external apparatus, such as a personal computer. In this case, the scanner device 100 receives, via the communication I/F, instruction information corresponding to an instruction operation accepted in the personal computer.

In response to the instruction operation accepted via the operating panel or the instruction information received via the communication I/F, the scanner device 100 can, for example, move the scanner carriage 220, turn on or off the reflective light source 215 and the transmissive light source 318, and generate image data by photoelectrically converting light forming as an image on the image pickup element 217.

The scanner device 100 may store the generated image data in any storage medium or may transmit it to an external apparatus, such as a personal computer, via the communication I/F.

To cause the scanner device 100 having the structure described above to read a transparent document, a user sets the film holder 600 on the document table glass 212 and sets the transparent document at a predetermined position shown by the film holder 600. The user detaches the protective mat 232 from the TPU housing 230 before or after the transparent document is set.

Subsequently, as illustrated in FIGS. 1 and 2, the TPU unit 120 is made to face the main body unit 110. Thus, the gear 310 and the gear 313 of the coupling mechanism 309 are coupled together via the gear 601, and the image pickup element moving mechanism 223 and the light source moving mechanism 323 are coupled together.

After that, the user performs an operation of an instruction to read an image of the transparent document. The user may perform the instruction operation via the operating panel provided in the scanner device 100 or using an external apparatus, such as a personal computer.

When an operation of an instruction to read an image of the transparent document is performed, the scanner device 100 drives the motor 222, moves the scanner carriage 220 and the transmissive light source 318 in the sub-scanning direction, and detects the amount of light received in the image pickup element 217 while moving them. The scanner device 100 generates image data based on the detected amount of light received.

Various kinds of reference data used as the reference of black and white in the image data may be obtained prior to the generation of the image data, and the image data may be subjected to shading compensation using the obtained reference data. Each of the obtainment of the reference data and the shading compensation using the obtained reference data is a publicly known technique, so the description thereof is omitted here.

As described above, according to the scanner device 100 in the first embodiment, the single motor 222 can actualize a driving source for both the light source moving mechanism 323 and the image pickup element moving mechanism 223. Thus, the size and weight of the scanner device 100 can be reduced, compared with when the light source moving mechanism 323 and the image pickup element moving mechanism 223 have respective independent motors.

In addition, according to the scanner device 100 in the first embodiment, because the driving force is transmitted to the light source moving mechanism 323 only when the film holder 600 is positioned in the set position to read a transparent document, power consumption of the motor 222 can be minimized. Positioning the film holder 600 in the set position is a normal operation that must be performed by a user to cause the scanner device 100 to read a transparent document. Thus, the light source moving mechanism 323 and the image pickup element moving mechanism 223 can be coupled together without the need for a special operation for coupling them from the user. Accordingly, the power consumption of the motor 222 can be minimized without sacrificing user convenience.

Moreover, according to the scanner device 100 in the first embodiment, because the driving force is transmitted to the light source moving mechanism 323 only when the film holder 600 is positioned in the set position to read a transparent document, a load imposed on the motor 222 can also be minimized. Thus, durability of the scanner device 100 can be increased, compared with when the driving force is also transmitted to the light source moving mechanism 323 during reading of a transmissive document.

In the foregoing, positioning of the film holder 600 in the set position makes the gear 601 mesh with the gear 310 and the gear 313. However, in contrast to this, when the gear 601 is positioned in a position at which the gear 601 meshes with the gear 310 and the gear 313 and is coupled thereto, the film holder 600 may be positioned in the set position. This can eliminate the necessity for a special structure for positioning the film holder 600.

### Second Embodiment

An image reading device according to a second preferred embodiment of the invention is described below with reference to the accompanying drawings. The second embodiment indicates an application example to a scanner device that actualizes the image reading device according to the invention. In the second embodiment, the same reference numerals are used as in the first embodiment for similar parts, and the description thereof is omitted.

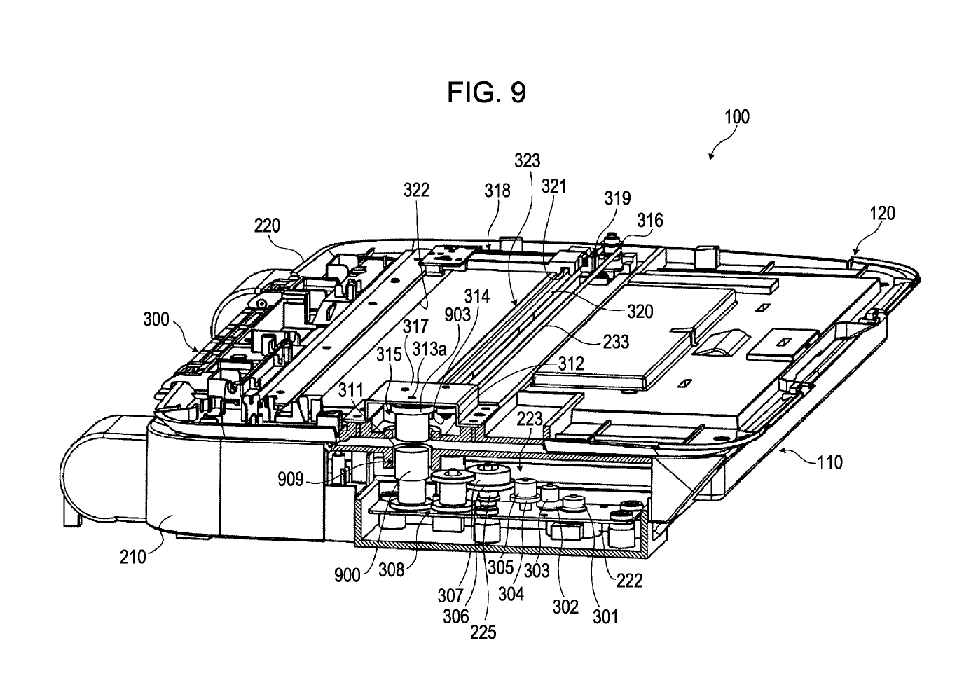

FIG. 9 is a partial cutaway perspective view of the scanner device according to the second embodiment. FIG. 9 illustrates a section when a part of the TPU housing 230 and the main body housing 210 is cut. Each component to which the driving force of the motor 222 is transmitted will be described below using FIG. 9.

As illustrated in FIG. 9, the pulley 307 included in the scanner device 100 according to the second embodiment is coupled to a magnetic body 900 via the group of pulleys 308. The magnetic body 900 is a rotary member constituting a part of a coupling mechanism 909. The magnetic body 900 is rotated about an axis parallel with a direction of the axes of the group of pulleys 308 by receiving the driving force of the motor 222 transmitted via the group of pulleys 308.

The magnetic body 900 is arranged so as to face a magnetic body 903 disposed on the TPU unit 120 with the openings 311 and 312, which are open to the TPU unit 120 at the upper surface of the main body housing 210, arranged therebetween. The pulley 307, the group of pulleys 308, the magnetic body 900, the openings 311 and 312, and the magnetic body 903 constitute the coupling mechanism 909. The magnetic body 903 is rotatable about an axis parallel with the axis of the magnetic body 900 with respect to the shaft 313a.

In a state in which the film holder 600 is not positioned in the set position of the main body unit 110, a gap is also present between the magnetic body 903 and the magnetic body 900 even when the main body unit 110 and the TPU unit 120 are opposed to each other. Accordingly, the driving force of the motor 222 is not transmitted to the transmissive light source 318 (see FIG. 3).

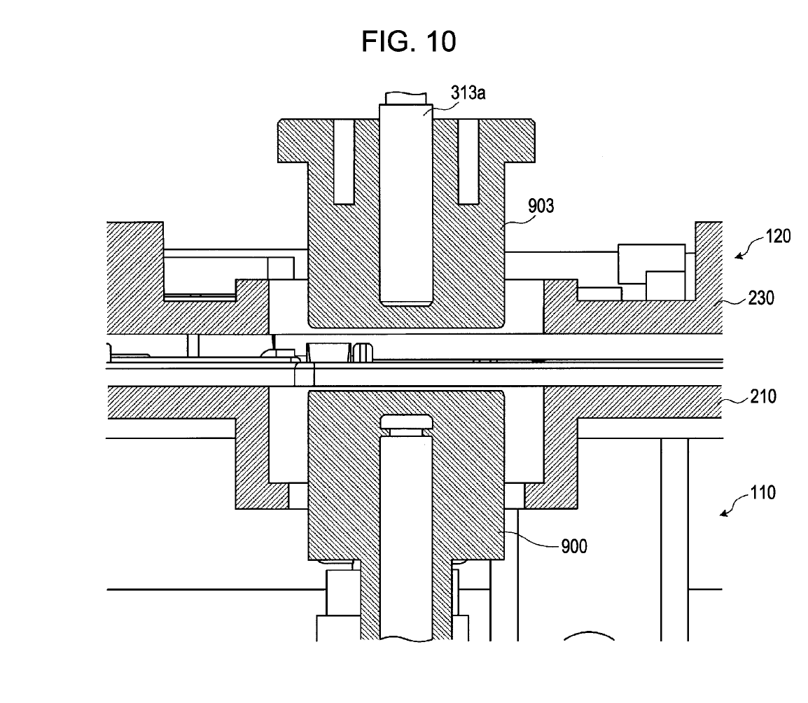

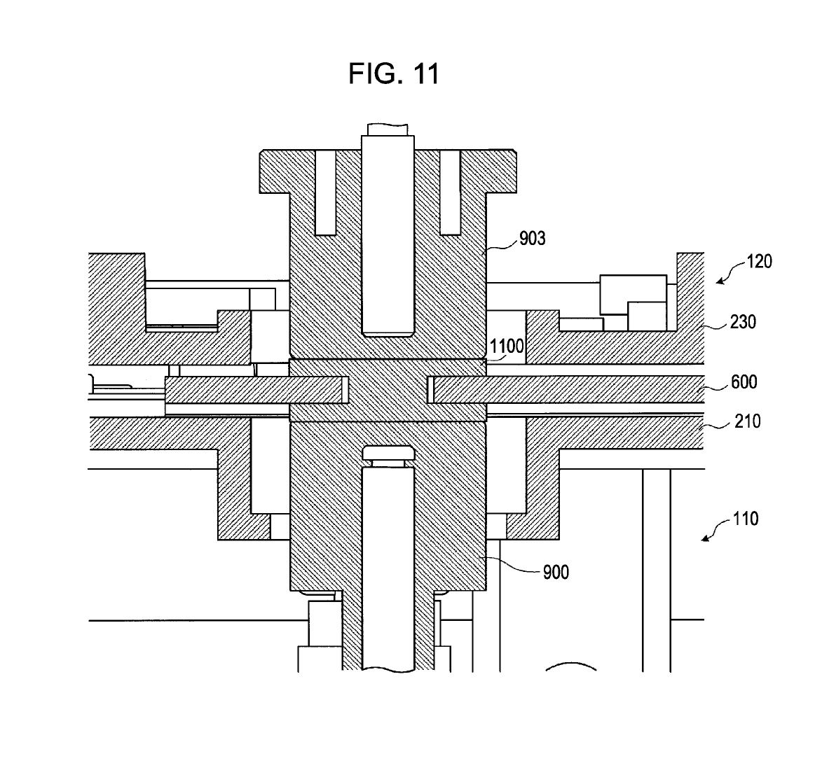

FIG. 10 is a (first) cut front view that illustrates an enlarged part of the scanner device. FIG. 11 is a (second) vertical cut front view that illustrates the enlarged part of the scanner device. FIG. 10 illustrates a state in which the film holder 600 is detached from the set position of the main body unit 110. FIG. 11 illustrates a state in which the film holder 600 is positioned in the set position of the main body unit 110.

As illustrated in FIG. 10, the shaft 313a of the scanner device 100 according to the second embodiment is provided with the magnetic body 903 rotatable with respect to the shaft 313a as an alternative to the gear 313. Similarly, the magnetic body 900 is provided as an alternative to the gear 310.

As illustrated in FIG. 11, the film holder 600 of the scanner device 100 according to the second embodiment is provided with a magnetic body 1100 as an alternative to the gear 601. The magnetic body 1100 is rotatable about an axis orthogonal to a surface of the film holder 600, as in the case of the gear 601. When the main body unit 110 and the TPU unit 120 are made to be opposed to each other in a state in which the film holder 600 is positioned in the set position of the main body unit 110, the magnetic force couples the magnetic body 1100 and the magnetic body 903 together and couples the magnetic body 1100 and the magnetic body 900 together, and the driving force of the motor 222 is transmitted to the transmissive light source 318 (see FIG. 3).

All of the magnetic bodies 900, 903, and 1100 in the coupling mechanism 909 may have magnetic forces attracting each other, or alternatively, at least one of them may have a magnetic force. When one of the magnetic bodies 900, 903, and 1100 has a magnetic force, the other magnetic bodies are made of a material that is attracted by a magnetic force, such as iron.

The opposing surfaces of the magnetic bodies 900, 903, and 1100 that face each other are flat. This allows each of the surfaces on which attractive forces are to be exerted to have a larger area and thus enables reliable coupling of the magnetic body 900 and the magnetic body 1100 and that of the magnetic body 903 and the magnetic body 1100. The flat opposing surfaces of the magnetic bodies 900, 903, and 1100 are orthogonal to a direction in which the magnetic bodies 900, 903, and 1100 face each other. Thus, the coupling mechanism 909 has the torque limiting function of causing a slip between the magnetic body 900 and the magnetic body 903 when a torque transmitted from the image pickup element moving mechanism 223 is larger than a predetermined magnitude to prevent the torque larger than the predetermined magnitude from being transmitted to the pulley group 315.

The predetermined magnitude of torque is a torque required to move the transmissive light source 318. The torque limiting function in the coupling mechanism 909 can protect the components involved in movement of the transmissive light source 318, for example, the transmissive light source 318, the pulley group 315, the pair of gears around which the driving belt 233 is wound, or the like, from damage.

As described above, according to the scanner device 100 in the second embodiment, the single motor 222 can actualize a driving source for both the light source moving mechanism 323 and the image pickup element moving mechanism 223. Thus, the size and weight of the scanner device 100 can be reduced, compared with when the light source moving mechanism 323 and the image pickup element moving mechanism 223 have respective independent motors.

According to the scanner device 100 in the second embodiment, because the driving force is transmitted to the light source moving mechanism 323 only when the film holder 600 is positioned in the set position to read a transparent document, power consumption of the motor 222 can be minimized. Positioning the film holder 600 in the set position is a normal operation that must be performed by a user to cause the scanner device 100 to read a transparent document. Thus, the light source moving mechanism 323 and the image pickup element moving mechanism 223 can be coupled together without the need for a special operation for coupling them from the user. Accordingly, the power consumption of the motor 222 can be minimized without sacrificing user convenience.

According to the scanner device 100 in the second embodiment, because the driving force is transmitted to the light source moving mechanism 323 only when the film holder 600 is positioned in the set position to read a transparent document, a load imposed on the motor 222 can also be minimized. Thus, durability of the scanner device 100 can be increased, compared with when the driving force is also transmitted to the light source moving mechanism 323 during reading of a transmissive document.

According to the scanner device 100 in the second embodiment, the torque limiting function in the coupling mechanism 909 can protect the components involved in movement of the transmissive light source 318, for example, the transmissive light source 318, the pulley group 315, the pair of gears around which the driving belt 233 is wound, or the like, from damage. Thus, durability of each component involved in movement of the transmissive light source 318 can be increased.

### Third Embodiment

An image reading device according to a third preferred embodiment of the invention is described below with reference to the accompanying drawings. The third embodiment indicates an application example to a multifunction apparatus that actualizes the image reading device and an image forming device according to the invention. In the third embodiment, the same reference numerals are used as in the first and second embodiments for similar parts, and the description thereof is omitted.

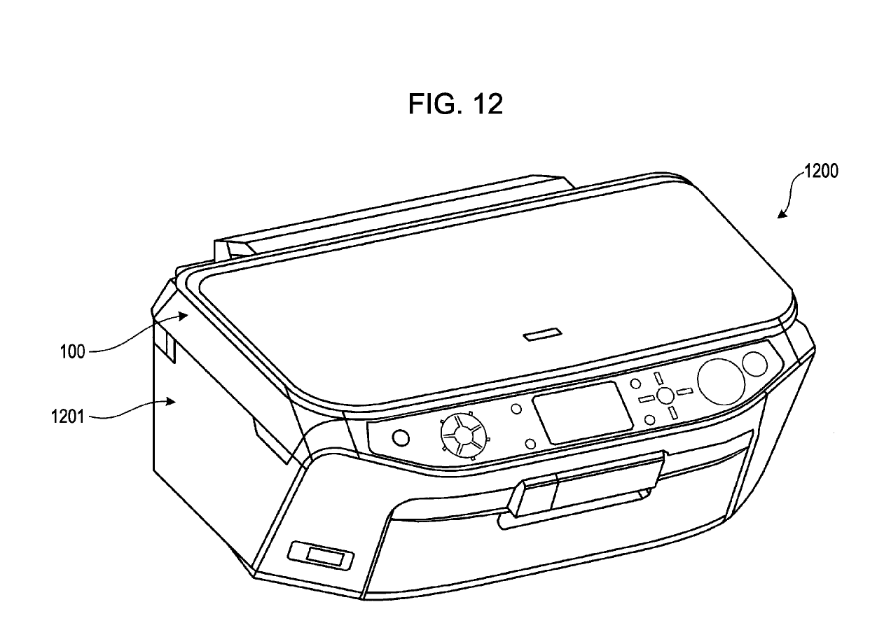

FIG. 12 is a perspective view that illustrates an outer appearance of a multifunction apparatus according to the third embodiment. A multifunction apparatus 1200 according to the third embodiment includes the scanner device 100, which is described in the first and second embodiments, and a printer 1201 serving as an image forming device that forms, on a recording medium, an image corresponding to the intensity of light incident on the image pickup element 217 included in the scanner device 100.

The scanner device 100 and the printer 1201 are connected together via a communication I/F (not illustrated) so as to be able to communicate with each other. The scanner device 100 outputs image data corresponding to the intensity of light incident on the image pickup element 217 to the printer 1201.

The printer 1201 includes a printer engine that forms an image on a recording medium, such as paper. Although not illustrated and described because they are publicly known techniques, various methods, such as the ink jet method, the electrostatic transfer method, and the dye-sublimation transfer method, can be applied as an image forming method for use in the printer engine.

The printer 1201 in the multifunction apparatus 1200 having the above structure forms an image on a recording medium, such as paper, on the basis of image data output from the scanner device 100.

With this multifunction apparatus 1200, an image based on image data reproduced from an image of a document with high precision can be formed on a recording medium, such as paper, for any kind of document. Thus, for any kind of document, a user can obtain a recording medium on which an image based on image data reproduced from an image of a document with high precision is formed.

1. An image reading device comprising a first light source disposed at the same side as a side at which an image pickup element is disposed with respect to a document table and a second light source disposed at a side opposite the image pickup element with the document table arranged therebetween, the image reading device comprising:
an image pickup element moving mechanism that moves the image pickup element in a sub-scanning direction;
a light source moving mechanism that moves the second light source in the sub-scanning direction;
a positioning member that is movable to a set position on the document table and to a different position from the set position and that shows a set position for a transparent document when being positioned in the set position; and
a coupling mechanism that couples the image pickup element moving mechanism and the light source moving mechanism together such that both the moving mechanisms are capable of working together when the positioning member is positioned in the set position.

2. The image reading device according to claim 1, wherein the coupling mechanism includes a rotary member that is disposed on the positioning member and that is movable with respect to the positioning member, and the coupling mechanism couples the image pickup element moving mechanism and the light source moving mechanism together such that both the moving mechanisms are capable of working together via the rotary member when the positioning member is positioned in the set position.

3. The image reading device according to claim 2, wherein the coupling mechanism includes a magnetic body and couples the image pickup element moving mechanism and the light source moving mechanism together such that both the moving mechanisms are capable of working together by using the magnetic force of the magnetic body.

4. The image reading device according to claim 3, wherein the coupling mechanism includes coupling members that are attracted by the magnetic force of the magnetic body, and the coupling members couple the image pickup element moving mechanism and the light source moving mechanism together such that both the moving mechanisms are capable of working together by causing flat surfaces orthogonal to a direction in which the coupling members face each other to come into contact with each other.

5. The image reading device according to claim 4, wherein the rotary member positions the positioning member to the set position when being positioned in a position for coupling the image pickup element moving mechanism and the light source moving mechanism together.

6. The image reading device according to claim 5, further comprising:
a cover member that is shaped so as to block outside light from being incident on the image pickup element through the document table and that is capable of being in contact with and separated from the document table,
wherein the second light source is disposed on the cover member.

7. The image reading device according to claim 6, wherein the second light source includes a light-emitting diode (LED).

8. A multifunction apparatus comprising:
an image reading device including a first light source disposed at the same side as a side at which an image pickup element is disposed with respect to a document table and a second light source disposed at a side opposite the image pickup element with the document table arranged therebetween, the image reading device including:
an image pickup element moving mechanism that moves the image pickup element in a sub-scanning direction,
a light source moving mechanism that moves the second light source in the sub-scanning direction,
a positioning member that is movable to a set position on the document table and to a different position from the set position and that shows a set position for a transparent document when being positioned in the set position, and
a coupling mechanism that couples the image pickup element moving mechanism and the light source moving mechanism together such that both the moving mechanisms are capable of working together when the positioning member is positioned in the set position; and
an image forming device that forms, on a recording medium, an image corresponding to intensity of light incident on the image pickup element included in the image reading device.

9. The multifunction apparatus according to claim 8, wherein the coupling mechanism includes a rotary member that is disposed on the positioning member and that is movable with respect to the positioning member, and the coupling mechanism couples the image pickup element moving mechanism and the light source moving mechanism together such that both the moving mechanisms are capable of working together via the rotary member when the positioning member is positioned in the set position.

10. The multifunction apparatus according to claim 9, wherein the coupling mechanism includes a magnetic body and couples the image pickup element moving mechanism and the light source moving mechanism together such that both the moving mechanisms are capable of working together by using the magnetic force of the magnetic body.

11. The multifunction apparatus according to claim 10, wherein the coupling mechanism includes coupling members that are attracted by the magnetic force of the magnetic body, and the coupling members couple the image pickup element moving mechanism and the light source moving mechanism together such that both the moving mechanisms are capable of working together by causing flat surfaces orthogonal to a direction in which the coupling members face each other to come into contact with each other.

12. The multifunction apparatus according to claim 11, wherein the rotary member positions the positioning member to the set position when being positioned in a position for coupling the image pickup element moving mechanism and the light source moving mechanism together.

13. The multifunction apparatus according to claim 12, further comprising:
a cover member that is shaped so as to block outside light from being incident on the image pickup element through the document table and that is capable of being in contact with and separated from the document table,
wherein the second light source is disposed on the cover member.

14. The multifunction apparatus according to claim 13, wherein the second light source includes a light-emitting diode (LED).
